(19) United States
(12) Patent Application Publication
(10) Pub. No.: US 2010/0159982 A1
(43) Pub. Date: Jun. 24, 2010

(54) MOBILE GLUCOSTRESS PHONE

(76) Inventor: Gastón Jeronimo Verri Lima, Montevideo (UY)

Correspondence Address: Leason Ellis LLP, 81 Main Street, Suite 503, White Plains, NY, 10601, US

(21) Appl. No.: 12/602,370

(22) PCT Filed: Jun. 3, 2008
(86) PCT No.: PCT/IT08/00367

§ 371 Date: Mar. 9, 2010

(30) Foreign Application Priority Data
May 31, 2007 (UY) 30380

(51) Int. Cl. H04W 88/02

(52) U.S. Cl. 455/556.1

(57) ABSTRACT

The Mobile Glucostress Phone is a device characterized by a mobile telephone or cellular telephone or mobile communication device integrated to one, two, three or four of the following analyzers: A) gluceinia analyzer, B) oxygen transcutaneous tension analyzer, C) electrocardiographic activity and cardiac frequency, and D) arterial pressure and pulse frequency analyzer. Every analyzer mentioned comprises one or more sensors and wireless transducers with power source and emission of precodified signal and further comprises means for connecting by wire with the Mobile Glucostress Phone.

The creation whose patent is applied for consists of a mobile phone or cellular phone or device of mobile communication, with computer support system, with screen and with or without camera sight, where there are incorporated one or more of the following components: A) one analyzer of oxygen transcutaneous tension (or transcutaneous oximeter) with its (one or more) respective sensors and electronic transducers, B) and/or an analyzer of glucemia with sensor and digital transducer (for analysis by digital luminous beam) or with sensor and transducer for blood sample reactive strip for the analysis of glucemia (also denominated hemoglucotest), C) and/or an analyzer of arterial pressure and pulse frequency with its device of wireless signal, D) and/or an analyzer of electrocardiographic activity and cardiac frequency with its (one or more) respective sensors and transducers. The mobile glucostress phone has its corresponding receptors of precodified signal sent by those wireless devices from a single or each one of said analyzers. The computer support system is for filing the parameters obtained by a single or for each one of the analyzers, and in order to see such data whenever we want.

The analyzer of electrocardiographic activity and cardiac frequency is a device implanted in the mobile glucostress phone, that has, preferably, three bracelets to be adjusted to the limbs with their respective sensors or wireless transducers which obtain the electrocardiographic signal. (Electrocardiographic layout and, also, of cardiac frequency), feeding fountain and fountains of emission of precodified signals for the receptor in the mobile glucostress phone. The analyzer of electrocardiographic activity can also have a system of connection by wire from its (one or more) respective sensors and wireless transducers to the mobile glucostress phone. The analyzer of electrocardiographic activity implanted in the mobile glucostress phone can register its parameters through a single and wireless sensor and transducer (with the possibility of connection with the mobile glucostress phone) that could be installed in the thorax or limits.

The analyzer of artery pressure and pulse frequency is a peripheral device to the mobile glucostress phone which sends the signal to the mobile glucostress phone either wireless or when the situation requires it by a connection by wire. The analyzer of artery pressure and pulse frequency is a device that has a system that insufflates or deflates a little rubber sleeve that wraps the first of one or both arms, it also has a register system, a system of power feeding, and a system of wireless signal emission to the mobile glucostress phone. The analyzer of pressure artery and of wireless pulse frequency, may be connected in order to send the signal obtained to the mobile glucostress phone by wire connection or directly if the situation requires so. The peripheral device of the analyzer of pressure artery and pulse frequency of the mobile glucostress phone, can have a register independent screen, computer support, and can also deflate the sleeve immediately whenever it is required. The mobile glucostress phone when it has an artery pressure analyzer and pulse frequency, registers in the computer system data obtained of artery pressure and pulse frequency, and can be seen whenever wanted.

The transcutaneous oxygen analyzer is implanted in the mobile glucostress phone and has one or more sensors and transducers. When it has a single sensor and transducer it may be implanted in one of the borders of the mobile glucostress phone and analyze the oxygen transcutaneous tension by apposition of the sensor and transducer with whatever cutaneous region of the organism. Another way that the mobile glucostress phone may have of analyzing the oxygen transcutaneous tension is with a single wireless sensor and transducer, but with its respective feeding fountain of power and emission of precodified signal, and implanted in a digital device which obtains the signal from one of the fingers of the hand (preferably the third finger of the left hand), or one of the fists (when having sensor and transducer incorporated to one of the bracelets). When the mobile glucostress phone has two or three wireless sensors and transducers, these will be implanted in the same bracelets of both fists and foot (preferably the left one) where are also the respective sensors and transducers that register the electrocardiographic activity and cardiac frequency. When the situation so requires, the mobile glucostress phone may obtain the signals for the oxygen transcutaneous analyzer from the corresponding wireless devices (sensors and transducers), using the (one or more) connections by wire.

The glucemia analyzer and the sensor with transducer for blood sample reactive strip of glucemia may be implanted in the mobile glucostress phone. Another way of analyzing the glucemia in the mobile glucostress phone is with the analyzer implanted in said phone and its sensor and wireless transducer for blood sample reactive strip, or its sensor and wireless transducer of glucemia by detection of luminous digital signal, with its respective power feeding fountain and precodified signal emission. When the situation requires it, the analyzer of glucemia with its sensor and wireless transducer or the mobile glucostress phone, may be operated through wire.

Sampling signals obtained by the mobile glucostress phone of oxygen transcutaneous tension analyzers, and/or glucemia, and/or artery pressure and pulse frequency, and/or electrocardiographic activity (electrocardiographic strip) and of pulse frequency, it will be possible to evaluate in the monitor or the screen of the cellular phone or device of mobile communication (or cellular) in the forms of sequence, individually or the whole. The results of glucemia, and/or artery pressure and pulse frequency, and/or electrocardiographic strip and cardiac frequency, and/or oxygen transcutaneous tension, may be sent to a switchboard to be examined, which also registers said parameters, through the mobile glucostress phone by the telephone signal sent by the web operator available. The device files the obtained parameters. In this way it is possible a direct and immediate communication from the switchboard with qualified technical team and the user who talks, or while talking and direct visualization in the case there it counts with sight (when the user wants it). The communication gives the potentiality of answering with immediate qualified technical medical assistance when the situation demands it.

At the switchboard there are also registered the parameters obtained and are filed in a data base, if the user authorizes it. The user may send the signals simultaneously or independently, previously selecting them, to the switchboard without having to communicate either verbally or visually, as he uses the communication by telephone offered by the web server. In the case of receiving a call at the moment of sending through the web server, the signals of the parameters obtained by the mobile glucostress phone to the switchboard, the user if he wants to, may interrupt the emission of the signals to answer the call, or answer the call without interrupting the sending of the parameters by the telephone signal of the web server. If at the switchboard alterations are detected in any of the parameters obtained, the user may be assisted and the communication may be suspended between the user and the third party in the line.

When the use of cellulars or similar devices are prohibited (planes, banks, etc.), there are connection terminals which are specific and are identified in the mobile glucostress phone so as to emit the corresponding signals to the register of parameters obtained by the analyzers (the connection will be made by the web server but instead made by telephone line, by urban wire or other system).

The mobile glucostress phone is for use in the field of cellular telephony integrated to medical assistance. This device is designed in order to answer a demand in the cellular or mobile telephony and/or medical assistance.

Like other elements of the procedure, the mobile glucostress phone allows, if the user wants it, an immediate answer by a qualified medical team in the proximity. In case the patient is seriously ill, as a result of the study of the parameters sent, immediate medical assistance should he given through mobile emergency units. The medical team which is codified from the switchboard by other qualified team which does the supervision, may be whichever mobile medical assistance there is in the proximity or the user needs regarding his clinical situation. The user may want to leave under digital custody in the switchboard his clinic story so as to facilitate a diagnosis and the corresponding assistance. Calls made by third parties to the user, at the moment these three devices incorporated to the mobile glucostress phone are utilized or when assistance is given from the switchboard, are announced and remain waiting for an answer, in order to give priority to obtaining the parameters sought and assistance from the switchboard as required.

This integrated device is also of utility to give assistance to sportsmen during their exercise, without the need of establishing visual or aural communication of the mobile glucostress phone. This device, making use of the signals of the different vital parameters previously defined and in view of danger for the patient, the latter could be immediately informed and assistance be given. In this ease the mobile glucostress phone may be installed in one of the arms.

### STATE OF THE ART

1) It is of public knowledge and of frequent use in medicine the analyzers of electrocardiographic activity and cardiac frequency (also named electrocardiographs, and these are defined as instruments for registering electrical activity of the myocardium in order to detect anomalies in the transmission of the cardiac impulse through the conductive tissue of the muscle) with systems of detection registered through devices put in the extreme of the four limbs (fists and toes) which are connected by wire to the electrocardiographic analyzer. It is also frequent they can be registered in paper and visualized in a screen. These analyzers of “conventional” use in medicine do not have backing of their registers in a computer system. It is not, also, a universal feature in the field of medicine, analyzers of electrical cardiac activity with wireless transducer for the limbs, with potentiality of being connected by wire in special circumstances like when flying a plane or prohibited areas.

Even less there have been developed analyzers of electrocardiographic activity and cardiac frequency integrated to a mobile telephone or cellular phone or device of mobile communication, with wireless sensor and transducer of signal, with potentiality of connection by wire. Neither have been developed systems that according to the will Of the user, communicate said parameters to a switchboard through a web.

There are 110 solutions regarding electrocardiographic analyzers and of cardiac frequency integrated to mobile telephones, or cellular phones or devices of mobile communication.

2) It is of public knowledge and of frequent use analyzers of arterial pressure named in medicine as esfingomanometers (its definition being: device to determine arterial pressure that consists of a little sleeve for the arm and leg. It has an air hag communicated with a tube through which it is filled with air with the help of a bulb and a manometer that indicates the amount of pressure exerted in the artery), its method of register is entirely mechanic.

Recently there have appeared arterial pressure analyzers with mechanic devices integrated with electronic ones that also register pulse frequency which is homologous, in certain instances, to cardiac frequency.

No solutions have been found regarding register and computer backing of these data. Neither have been found solutions in the monitoring of data obtained with register and backing in a computer system, in a wireless connection form to a mobile telephone, cellular phone or device of mobile communication, that can also he connected to a switchboard through a web server (if the user wants to), and that could also have, the said wireless system of analysis of artery pressure and cardiac frequency, the potentiality of connection by wire with the mobile glucostress phone.

There are no solutions regarding wireless devices for analysis of artery pressure and of pulse frequency, in conjunction with mobile telephones, cellular telephones or devices of mobile communication.

3) It is of public knowledge and of frequent use in medicine and at the domicile of the analyzers of glucemia with the use of reactive strips for blood sample, and it is usually denominated as hemoglucotest or glucometer (defined as an instrument that measures the levels of glucose in blood). It is riot of frequent use the analysis of glucemia by refraction of the luminous beam at the distal region of the fingers over the nail. There are no solutions containing in an integrated way mobile telephones, cellular phones, or devices of mobile communication with the glucemia analyzers in their forms of resister through a sensor and transducer for wireless reactive strip or incorporated to the mobile telephone (or cellular telephone or device of mobile communication) or with sensor or transducer of wireless digital luminous beam. There are also no known solutions of mobile telephones or cellulars or devices of mobile communication integrated with analyzers of glucemia with sensors and wireless transducers, which also have the potentiality of use with connection by wire from the sensor and transducer to the integrated analyzer of glucemia of the mobile telephone (or device of mobile communication or cellular telephone). Being this of utility under, certain circumstances as when flying by plane or in prohibited areas. There are also no solutions of register and computer hacking of data obtained by the analyzer of flucemia integrated to the mobile telephone, and that at the same time could be connected immediately, if the user wants it, with a switchboard with qualified medical team through a telephone web server.

4) It is or public knowledge and used in medicine the analyzers of oxygen transcutaneous tension (these are instruments that register the partial pressure of oxygen using a heater in the electrode that is applied to the skin, in this way an increase in temperature is provoked, with a dilatation of the capillaries, increase in the flow of capillary blood, permeability of the skin to the diffusion of gases, by which the value of partial pressure of oxygen is obtained). There are no known solutions of oxygen transcutaneous analyzers with sensors and wireless transducers with potentiality to be connected by wire. There are no known solutions of analyzers of oxygen transcutaneous tension integrated to mobile telephones or the other devices, with sensors and transducers integrated to one of the borders of the mobile telephone or the other devices, or with one or more sensors and wireless transducers. There are also no solutions regarding the potentiality or connection by wire from the sensors and wireless transducers of the analyzer of oxygen transcutaneous tension incorporated to the mobile telephone for other devices), neither there are solutions for the register with computer backing of the obtained data. There are no solutions on the potentiality of sending these data through the telephonic web server to a switchboard immediately, which would allow advising or qualified technical medical assistance, if the user wants it or the situation requires so.

5) They are of public knowledge the mobile telephones or devices of mobile communication or cellular phones, the analyzers of oxygen transcutaneous tension, the glucemia analyzers, the electrocardiographic activity and cardiac frequency analyzers, and the analyzers of arterial pressure and pulse frequency. But there are no known solutions that let having a mobile telephone (or cellular phone or device of mobile communication) integrated with one or more of the latter components mentioned, and that at the same time they have a continuous, permanent register, with computer backing. There are also no known solutions of an eventual immediate technical medical assistance through a switchboard connected to the web server, if the user wants it or the situation requires so.

### OTHER FORMS OF INDUSTRIAL EXPLOITATION

Manufacture of the mobile glucostress phone will allow satisfaction of a demand of users who suffer cardiovascular illnesses and/or Diabetes Mellitus due to the high number of cases in both developed and developing countries. They could be commercialized by selling them and possibly together with assistance services in the area of cellular or mobile telephony, and/or in the technical medical field, and/or in the area of maintenance or calibration or selling of inputs.

### SKETCH OF THE FIGURE NO 1 OF THE MOBILE GLUCOSTRESS PHONE

1) Camera sight. 2)Screen of mobile glucostress phone, or cellular or device for mobile communication, that shows partially or totally the parameters analyzed according to the user. 3) Keyboard. 4) Bracelet for superior right limb with sensor and wireless transducer for the analysis of the electrocardiographic activity and cardiac frequency, with its feeding fountain and transmission of precodified signal. It may also count with sensor and wireless transducer of oxygen transcutaneous tension, fountain of power and transmission of precodified signal. 5) Bracelet for left superior limb with sensor and wireless transducer for the analysis of the electrocardiographic activity and cardiac frequency, with its feeding fountain and transmission of precodified signal. It may also count with sensor and wireless transducer of oxygen transcutaneous tension, fountain of power and transmission of precodified signal. 6)Bracelet for one of the inferior limbs (preferably left) with sensor and wireless transducer for analysis of the electrocardiographic activity and cardiac frequency, with its feeding fountain and transmission of precodified signal, it may also count with sensor and wireless transducer of oxygen transcutaneous tension, fountain of power and transmission of precodified signal. 7) Receptor of the strip of reactive blood sample for the glucemia analyzer. Device for the modality of glucemia analyzer all included in the mobile glucostress phone. 8) Wireless device of the glucemia analyzer with receptor of reactive blood sample, with transducer, fountain of power and transmitting of precodified signal. 9) Wireless sensor and transducer, with fountain of power and transmission of precodified signal of the oxygen transcutaneous tension, for the modality of single sensor applied to one of the fingers of the hand (preferably third finger of the left hand). 10) Wireless analyzer of arterial pressure and pulse frequency of the mobile glucostress phone, with fountain of power, fountain of transmission of precodified signal and mechanic system for inflation and deflation of little sleeve, with or without computer backing of the parameters obtained. 11) Device for connection by wire of; one or each one, of the different wireless devices of analysis of the mobile glucostress phone, for use as required.

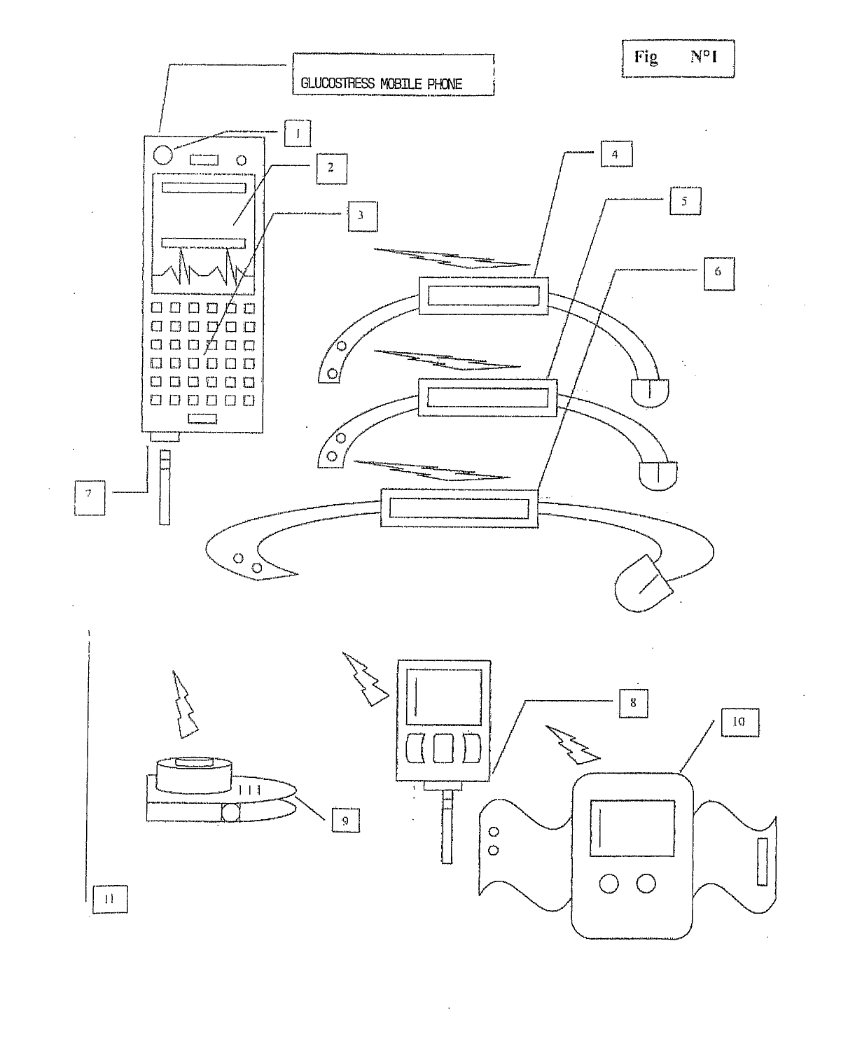

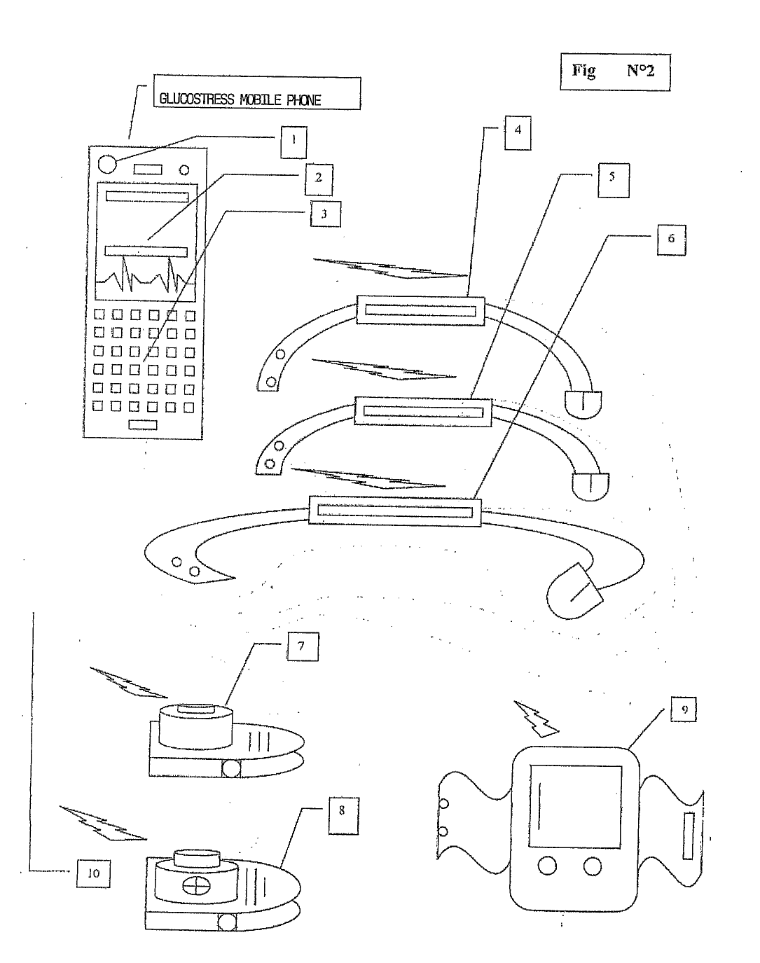

/N—There follow sketch of the FIG. 2 of the Mobile Glucostress Phone/

### SKETCH OF THE FIG. 2 OF THE MOBILE GLUCOSTRESS PHONE

1) Camera sight. 2)Screen of mobile glucostress phone, or cellular or device for mobile communication, that shows partially or totally the parameters analyzed according to the user. 3) Keyboard, 4)Bracelet for superior right limb with sensor and wireless transducer for the analysis of the electrocardiographic activity and cardiac frequency, with its feeding fountain and transmission of precodified signal. It may also count with sensor and wireless transducer of oxygen transcutaneous tension, fountain of power and transmission of precodified signal. 5) Bracelet for left superior limb with sensor and wireless transducer for the analysis of the electrocardiographic activity and cardiac frequency, with its feeding fountain and transmission of precodified signal. It may also count with sensor and wireless transducer of oxygen transcutaneous tension, fountain of power and transmission of precodified signal. 6) Bracelet for one of the inferior limbs (preferably left) with sensor and wireless transducer for analysis of the electrocardiographic activity and cardiac frequency, with its feeding fountain and transmission of precodified signal. It may also count with sensor and wireless transducer of oxygen transcutaneous tension, fountain of power and transmission of precodified signal. 7) Wireless sensor and transducer, with fountain of power and transmission of precodified signal of the oxygen transcutaneous tension, for the modality of single sensor applied to one of the fingers of the hand (preferably third finger of the left hand). Wireless sensor and transducer of the glucemia analyzer in the modality of incidence of luminous beam, to apply to the distal sector of fingers of the band, with its fountain of power and transmission of precodified signal. 9) Analyzer of arterial pressure and pulse frequency and of Device of pulse frequency of the Mobile Glucostress Phone, with fountain of power, fountain of transmission of precodified signal and mechanic system for inflation and deflation of little sleeve, with or without computer backing of the parameters obtained. 10) Device for connection by wire of, one or each one, of the different wireless devices of the analyzers of the Mobile Glucostress Phone, for use as required.

/N—There Follow sketch of the FIG. 2 of the Mobile Glucostress Phone/

1. (canceled)

2. (canceled)

3. A mobile device for the measurement and communication of physiological parameters, comprising:
a mobile communication device having a processor and being capable of transmitting data to a wireless communication network; and
a glycaemia analyzer having a sensor for measuring blood glucose levels, wherein the glycaemia analyzer transmits the sensed blood glucose levels to the mobile communication device for transmission to the wireless communication network.
